(19) United States
(12) Patent Application Publication
(10) Pub. No.: US 2022/0188488 A1
(43) Pub. Date: Jun. 16, 2022

(54) FLOOR PLAN GENERATION

(71) Applicants: Ian Patrick, Harrisburg, NC (US); Erin Patrick, Harrisburg, NC (US)

(72) Inventors: Ian Patrick, Harrisburg, NC (US); Erin Patrick, Harrisburg, NC (US)

(21) Appl. No.: 17/547,370

(22) Filed: Dec. 10, 2021

Related U.S. Application Data
(60) Provisional application No. 63/124,233, filed on Dec. 11, 2020.

(51) Int. Cl. G06F 30/27; G06F 30/12; G06F 30/13

(52) U.S. Cl. CPC G06F 30/27; G06F 2111/02; G06F 30/13; G06F 30/12

(57) ABSTRACT

A system for the generation of floor plans comprising a memory having a set of computer readable computer instructions, and a central processor for executing the set of computer readable instructions, the set of computer readable instructions including a pair of GAN models, the first model (GAN-I) being the learning model for all types of floor plans to generate color-coded floor plans and the second model (GAN-II) being the learning model for all color-coded floor plans to generate original architectural plan.

### CROSS REFERENCE TO RELATED APPLICATION

This application claims the priority of the provisional application Ser. No. 63/124,233 filed Dec. 11, 2020. Applicant hereby incorporates by reference the entire content of provisional application Ser. No. 63/124,233.

### FIELD OF INVENTION

The present invention is related to a system and method of for generating architectural floor plans based on input from a system user and an Artificial Intelligence system.

### BACKGROUND OF THE INVENTION

Artificial Intelligence (AI) is wide-ranging branch of computer science concerned with building smart machines capable of performing tasks that typically require human intelligence. AI is an interdisciplinary science with multiple approaches, but advancements in machine learning and deep learning are creating a paradigm shift in virtually every sector of the tech industry.

AI may be classified under two broad categories, the first being Narrow AI and the second being Artificial General Intelligence (AGI). Narrow AI operates within a limited context and is a simulation of human intelligence. Narrow AI is often focused on performing a single task extremely well and while these machines may seem intelligent, they are operating under far more constraints and limitations than even the most basic human intelligence. Examples of Narrow AI include things like IBM's Watson, Alexa from Amazon, Siri from Apple, image recognition software, Google search and self-driving cars. Narrow AI is powered by both machine learning and deep learning. Machine learning feeds a computer data and uses statistical techniques to help it “learn” how to get progressively better at a task, without having been specifically programmed for that task, eliminating the need for millions of lines of written code. Machine learning consists of both supervised learning (using labeled data sets) and unsupervised learning (using unlabeled data sets). Deep learning is a type of machine learning that runs inputs through a neural network architecture similar to that of a biological neural network. The neural networks contain a number of hidden layers through which the data is processed, allowing the machine to go “deep” in its learning, making connections and weighting input for the best results.

AGI is much more complex and is essentially a machine with general intelligence with the ability to apply that intelligence to solve any problem presented to it. The computer HAL 9000 from the film 2001 and the android Data from Star Trek the Next Generation are prime examples of AGI.

AI is being used in a multitude of industries including, Energy, Financial Services, Government, Healthcare, Manufacturing, Media, Professional Services, Retail and Consumer Services, Telecommunications, and Transportation.

One industry which may benefit tremendously from the addition of AI is the architectural and building industry. Currently, architecture firms, construction firms, and design firms are evolving to include AI into the overall design and build process. AI may enhance a designer's ability to create a building space which is aesthetically superior due to the environment, topography or building materials available to a specific building site or region.

AI can also aid consumers in helping to create design and architectural plans based on the specific needs, desires, funds, and preferences of the consumer. AI could be designed to evaluate a multitude of factors to aid in designing residential and/or commercial properties. AI based floor plans will save consumers both time and money. With an AI based floor-plan generation system, there is no need for a human to complete these jobs manually and repeatedly. Humans are generally less efficient and are prone to error. Humans can focus on higher value tasks such as making fine enhancements over the AI generated plans. This saves time for the humans while costing them less to do the job. Thus, there is clearly a need for both a system and method that provides for the generation of original architectural floor plans based on input from a consumer and AI learning.

### SUMMARY OF THE INVENTION

A system for the generation of floor plans comprising a memory having a set of computer readable computer instructions, and a central processor for executing the set of computer readable instructions, the set of computer readable instructions including a pair of GAN models, the first model (GAN-I) being the learning model for all types of floor plans to generate color-coded floor plans and the second model (GAN-II) being the learning model for all color-coded floor plans to generate original architectural plans.

DESCRIPTION OF THE DRAWINGS

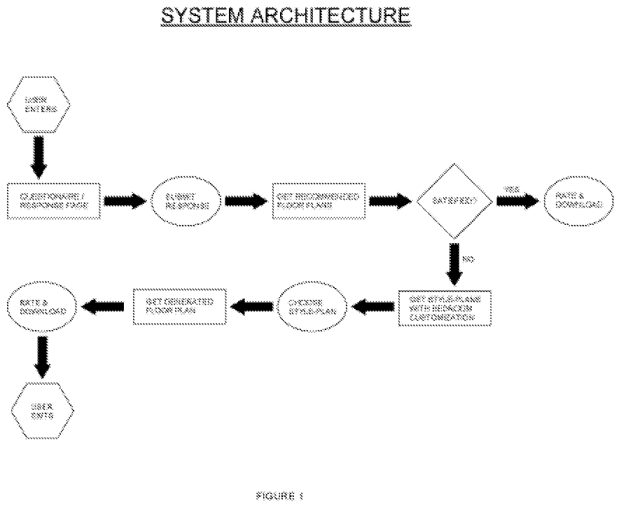

FIG. 1 is a flow diagram illustrating the system architecture of the current System.

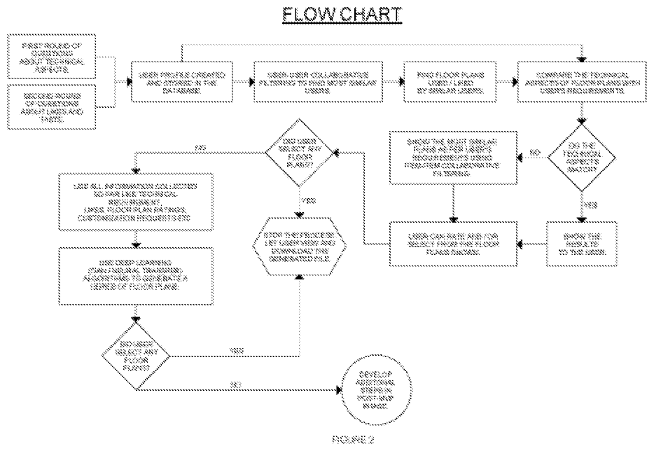

FIG. 2 is a flow diagram used in the current System.

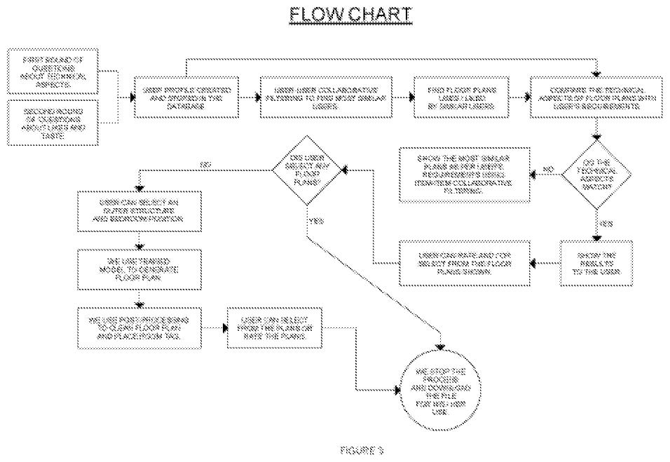

FIG. 3 is a flow diagram used in the current System.

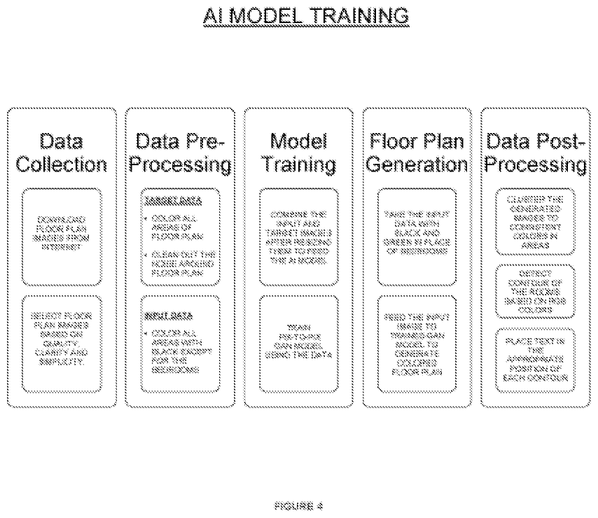

FIG. 4 is a flow diagram illustrating an embodiment of the AI Model Training utilized in the current System.

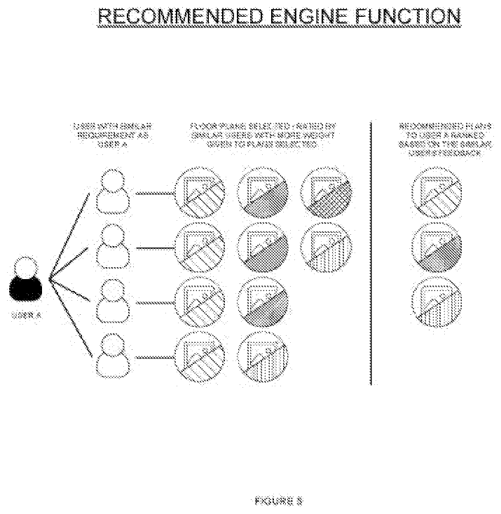

FIG. 5 is a diagram illustrating an embodiment of the function of the Recommendation Engine utilized in the current System.

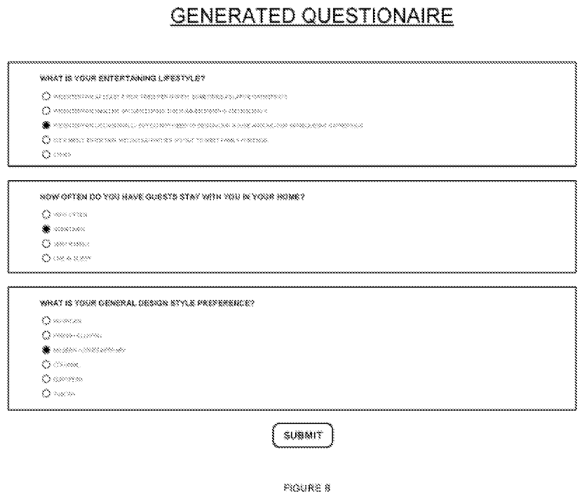

FIG. 6 is a screen shot of an embodiment of a questionnaire generated and utilized by the current System.

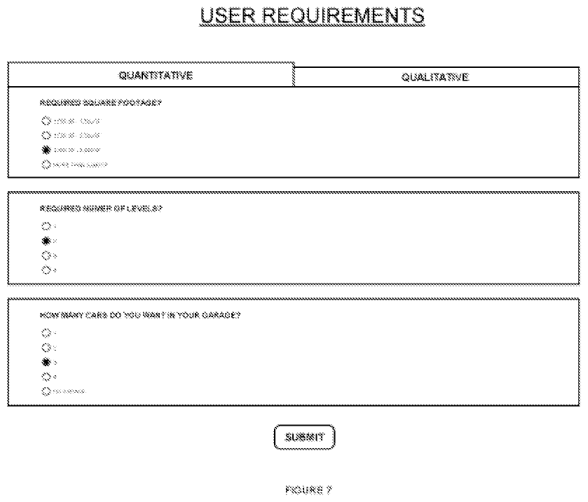

FIG. 7 is a screen shot of an embodiment of a Requirements Page generated by the System.

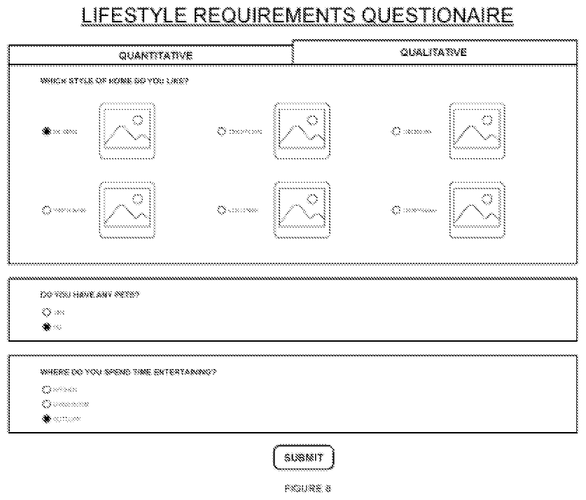

FIG. 8 is a screen shot of an embodiment of a Lifestyle Questions Page generated by the System.

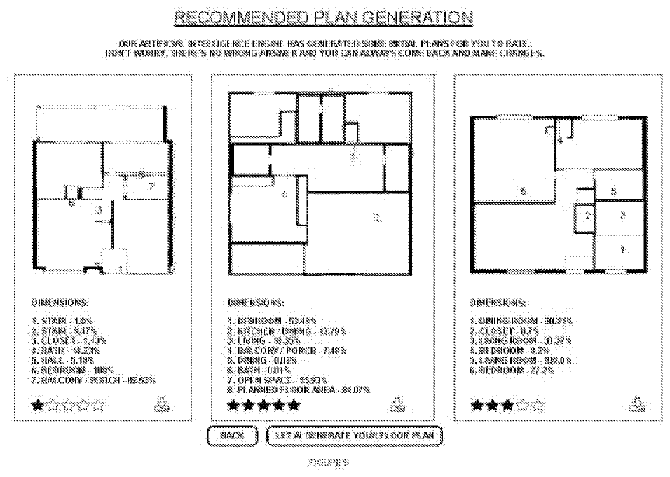

FIG. 9 is a screen shot of an embodiment of the Recommended Plans generated and presented by the System.

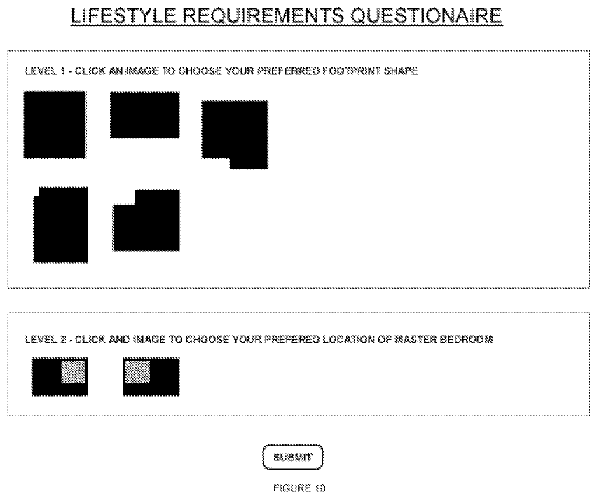

FIG. 10 is a screen shot of an embodiment of a Style Questions Page generated by the System.

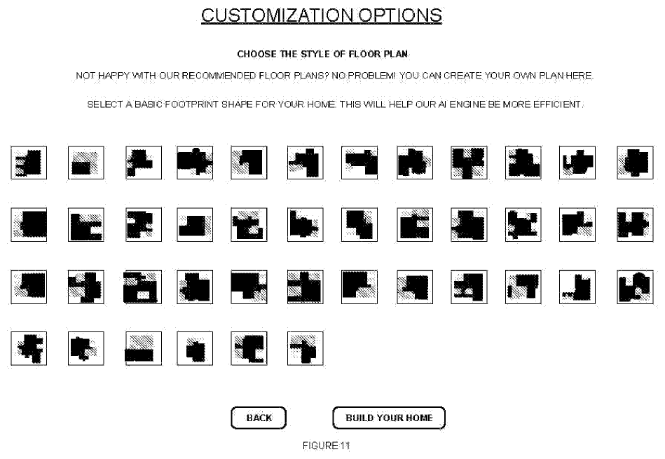

FIG. 11 is a screen shot of an embodiment of customization options generated and presented by the System.

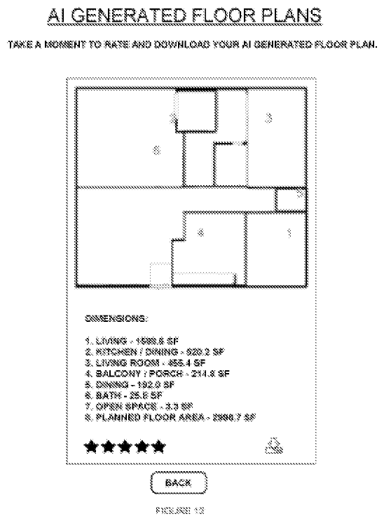

FIG. 12 is a screen shot of an embodiment of a Floor Plan Recommendations Page generated by the System.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A floor plan is an architectural depiction of the layout of a house. Descriptions and pretty pictures about the property are no longer satisfactory when it comes to buyers who want to purchase their homes in a fast and effective way. Unfortunately, creating a floor plan according to clients' requirement is a time consuming and expensive process requiring a skilled Architect engineer to create the plan. The instant invention is looking towards a futuristic plan where most floor plans will be created by an AI-based application and skilled Architect engineers can focus on either extending the base floor plans to higher levels or utilizing their skills on larger and more complex projects.

The instant invention includes a system and method for the generation of floor plans with the aid of Artificial Intelligence (AI). AI will be used to train the system through the collection and extrapolation of data from thousands of examples of architectural floor plans. The extrapolated data will then be utilized to generate and create original floor plans based on the needs and desires of a person using the system. The system will use Generative Adversarial Networks (GANs) which are an approach to generative modeling using deep learning methods, such as convolutional neural networks. More specifically, the instant invention includes a system for generating floor plans comprising of memory having a set of computer readable instructions, and a central processor for executing the set of computer readable computer instructions, the set of computer readable computer instructions including one or more GAN models, a first model (GAN-I) being a learning model for all types of floor plans to generate color-coded floor plans and a second model (GAN-II) being a learning model for all color-coded floor plans to generate original architectural plans. The central processor is comprised of one or more processors, one or more computers, one or more servers, and/or combinations thereof working in conjunction with one another. As the system expands and improves, the first model (GAN-I) acquires or learns from existing floor plans obtained from any source available including, but not limited to, online, online databases, private databased, scanned documents, public databases, and the like.

In one embodiment of the instant invention, the system for generating floor plans includes a memory having a set of computer readable computer instructions, and a central processor for executing the set of computer readable computer instructions. The set of computer readable computer instructions includes a pair of GAN models, a first model (GAN-I) being a learning model for all types of floor plans to generate color-coded floor plans and a second model (GAN-II) being a learning model for all color-coded floor plans to generate original architectural plans.

Generative modeling is an unsupervised learning task in machine learning that involves automatically discovering and learning the regularities or patterns in input data in such a way that the model can be used to generate or output new examples that plausibly could have been drawn from the original dataset. In the instant system, GANs will be used to train a generative model through the review and analysis of pre-existing architectural floor plans. The system will include two sub-models. The first sub-model will be a generator model that is trained to generate new examples. The second sub-model will be a discriminator model that tries to classify examples as either real (from the domain) or fake (generated). The two models are trained together in a zero-sum game, adversarial, until the discriminator model is fooled about half the time, meaning the generator model is generating plausible examples.

As stated previously, the instant system includes one or more layers of GAN models, with a first (GAN-I) being the learning model for all types of floor plans to generate color-coded floor plans for the same, and a second (GAN-II) being the learning model for all color-coded floor plans to generate the actual professional plans. Plans may further include plumbing impressions. Keeping the color codes for each room specified, the generated colored plans from the first layer of the GAN (GAN-I) model are cleaned using contour analysis. Contours can be thought of as a curve that joins all the continuous points along a boundary, having same color or intensity. The contours are a useful tool for shape analysis and object detection and recognition (e.g., OpenCV's contouring—masking the walls and boundaries).

The middle coordinates for each room are determined using the pixel location of the specified colors and the corresponding room names along with the determined coordinates are saved in a dictionary format. The colored rooms are processed further to find the area of each room as a percentage of the total pixels present. The length and width of each room is found out by number of pixels present in the line and, assuming it to be a rectangular room, the area is equal to length×width. The total floor area is determined by taking the boundary pixels. This percentage area for each room is saved in a dictionary format.

The results from the GAN-I model are used as input to the GAN-II model to generate the black/white images of the generated floor plan. Plans may optionally include plumbing impressions. The room names can be placed on top of each room of the GAN-II resulting images at the specified coordinates from the dictionary, saved beforehand. The dictionary having the areas of each room is also displayed in the user interface (UI) as a proportion of the floor area, as given input by the user in the questionnaire. Thus, the dimensions of all rooms are shown in the UI as an index to the plot having the floor plan.

Looking to the flow process illustrated in FIG. 1, the System Architecture is illustrated through the process of:
1) A User enters the system (i.e., online via a computing device)
2) The User enters information into the Questionnaire/Response page
3) The User submits their responses to the Questionnaire/Response page to the System
4) The System evaluates the responses and generates recommended floor plans and presents those plans to the User for review
5) If the User is satisfied with one the recommended floor plans, the User is able to rate and download the plan
6) If the User is not satisfied with one of the recommended plans, the System will generate and present style-plans with bedroom customization options
7) The User submits responses regarding the style plans and bedroom customization options presented
8) The System evaluates the responses and generates recommended floor plans and presents those plans to the User for review
9) If the User is satisfied with one the recommended floor plans, the User is able to rate and download the plan
10) The User exits the system

Looking to the flow process illustrated in FIGS. 2 and 3, the first round of questions involves the number of bedrooms, number of bathrooms, budget, building materials, lot dimensions, number of stories, municipal restrictions, neighborhood restrictions, special needs (i.e., handicap access, limited mobility access), closet size, and the like. The questions and their respective answers are pre stored in the database as the first set of input data including technical aspects of the floor plan and are labelled as fixtures during deployment of the application. The system stores the information in a database. A vector is created from the User's answers (first set of input data) and is stored along with its answers. Each user can only choose one answer to a question and can edit that information later if desired. The next round of questions is about lifestyle and more qualitative in nature. The second round of questions provides the second set of input data including the tastes and preferences of the user. Based on the user's answers, the System can apply “collaborative filtering” to locate other users with similar characteristics which are previously stored in the database. The Euclidean distance is calculated between the current user's vector and the previous users' vectors which are similar, and the most similar users are selected by the System. The System then averages the previous user's ratings for floor plan images and the top-rated floor plans are presented to the current user.

The System will then seek floor plans that were liked by other users of similar taste to the current user (from the second set of input data). The System would also search for floor plans which are similar in technical aspects to the current user (from the first set of input data). If the system fails to find a match using the collaborative filtering algorithm or based on the technical parameters, it will show the floor plans that are the closest match to the requirements of the current user. To do this, the System will use “item-item collaborative filtering”. Upon seeing the recommendations, the user will have the option to rate each of the floor plans and provide feedback as to how close was the match based on their requirements. This feedback is a revised set of input data which is used to retrain the models accordingly. Every user can have one rating per image and edit their ratings as they desire. Ratings to a specific floor plan by each individual user are stored in the database. Multiple users can give different ratings to the same floor plan. If the user selects a recommended floor plan as-is, then there are no further interactions required or initiated by the System as the System's goal has been achieved. The user can also select a specific floor plan and then suggest customizations to the System. The System would then generate the floor plan accordingly using Deep Learning algorithms. The user can now view and download the newly generated floor plan.

Looking now to FIG. 4, there is illustrated one embodiment of an AI Model Training Flow Diagram. The process begins with data collection which includes seeking out and downloading floor plan images from the internet to teach the system about existing floor plans and provide a basis for generating new floor plans. Floor plans are selected for download and evaluation based on quality, clarity and simplicity. After selection, data pre-processing begins by coloring all areas of each floor plan and removing any unwanted material (noise) in and around the floor plan. The system can then color all areas as black, with the exception of the bedrooms. The system then proceeds with Model Training by combining and input and target images after they have been re-sized for entry into the AI Model. The GAN-I model is trained by this Model Training. The system then moves on to Floor Plan Generation by taking the input data which was previously colored and cleaned up and using that data to generate floor plans through the GAN-II model. Data Post-Processing then clusters the generated images to ensure that consistent color is applied to desired areas (i.e., bedrooms). The contours of each room are detected based on the RGB colors assigned to them and text is entered in a desired location along each contour.

Looking to FIG. 5, it illustrates one embodiment of a Recommendation Engine used by the System. The Recommendation Engine operates using the following steps:
1. User A is asked to provide a set of his/her requirements and specifications.
2. Each user's response is converted into a vector representation for mathematical comparison.
3. User A is then compared with the present pool of users using Euclidean distance to find the level of similarity between.
4. The lesser the Euclidean distance, the higher the similarity is between User A and a random user from the pool.
5. The top similar users are considered for User A for the recommendation engine.
6. Each user has the privilege to rate the floor plans in their generation cycle. The floor plans which are best rated by the user are considered.
7. The most similar users' highly rated floor plans become the product of the recommendation engine.
8. The floor plans with the best rating by the top similar users are then recommended to User A.

FIGS. 6, 7 and 8 are all embodiments of the quantitative and qualitative questions generated by the System to collect data from each user. The user's responses to the qualitative and quantitative questions are used by the system to mathematically compare the current user's answers regarding their needs and preferences to the answers of previous users. Those responses and previous user comparisons are evaluated by the GAN-I and GAN-II of the System to generate and present one or more floor plan to the current user.

FIG. 9 is a screen shot of an embodiment of the Recommended Plans generated and presented by the System. The current user can then review and rate each of the recommended plans based on their needs and preferences. The System will use those ratings to attempt to improve recommendations for future users of the System. FIGS. 10 and 11 are screen shots of an embodiment of a Style Questions Page generated by the System. These allow a user to customize their selection based on both lot dimensions and aesthetic preferences. FIG. 12 is a screen shot of an embodiment of a Floor Plan Recommendations Page generated by the System.

### Functionalities of the System

### Frontend:

1. Login-logout-registration functionalities and interfaces.
2. Dynamic frontend question list display in the UI.
3. Display the dynamic frontend response list for each user based on the last choices made in UI.
4. Reselect the choices from the UI to update the last choice.
5. Display the recommended floor plans in UI.
6. Display the dimension list as a legend in the UI.
7. Rate and download each floor plan recommended.
8. Response handling functionality in frontend to get style plans having the number of bedrooms according to the choice made.
9. Choose a style-plan as input to the AI-GAN model.
10. Display the floor plan in UI
11. Get the dimension list as a legend along with the plan generated in UI
12. Rate and download each floor plan generated

### Backend:

1. Login-logout-registration functionalities.
2. Dynamic frontend question list based on the questions in the database.
3. Dynamic frontend response list for each user based on the last choices made (fetching customer by id).
4. Update response for each question for each user-backend & frontend (fetching customer by id).
5. Find similar users based on the responses chosen.
6. Find recommended floor plans based on the highly-rated plans by similar users.
7. Insert rating in Database for each floor plan recommended.
8. Get dimensions list having the area-percentage of each room for the recommended plans.
9. Tree-based structure on the style-plan images i.e user choosing #bedroom as 1 will get style plan images having 1 bedroom and likewise.
10. Invoke the GAN model as REST APIs.
11. Parameter tuning for the neural network used in GAN.
12. Clustering on GAN output images to get the color-cluster and centroid coordinate of each color-cluster.
13. Get the room-names based on the GAN-output color using Euclidean distance to determine the closest color.
14. Conversion of colored-plan to black/white plan.
15. Text placement using centroid coordinates from the clustering algorithm.
16. Find contour/room from each floor plan using OpenCV and corresponding parameter-tuning.
17. Find the relative area percentage of each contour wrt the whole floor plan.
18. Convert relative area percentage to the exact square foot area for the generated plan wrt the user's input of size of floor-area in Qs−1.
19. Rule constraint imposed on the coordinates based on the area of each cluster to display sensible dimensions.
20. Get the dimension list having the area in square feet, summing up to the floor size chosen by the user in the questionnaire.

The instant application as developed and the algorithms that it currently leverages basically solves “Space Optimization” problems. The algorithms determine, given a set of objects with strict dimensions and a space with its own dimensions, the best possible ways these objects can be put inside the space considering various rules.

For example, in our application, the whole floor plan is the space, and the various rooms are the various objects that have to fit in within the given floor plan. There are rules that must be followed to accomplish the fitment (e.g., The bathroom should be next to the bedroom.) In the same way, every room can be considered as another space and the typical objects of a room can be the various objects that need to be fit inside the room.

In addition to serving the business goals of the current application, the algorithms as developed can be extrapolated and used in various other industries too. The following are some the examples:
Packaging—Online Retailers can determine, given the items that need to be shipped, the most optimal box sizes in which all items can be packaged and hence save on shipping costs.
Furniture Design—Furniture manufacturers can, given the shape of a particular furniture, can determine the best possible ways to fit in all needed items in the most esthetical manner.
Automobile Manufacturing—Automobile manufacturers, given the shape of a particular vehicle, can determine the best possible ways to fit in all needed auto parts.
IC Chip Design—Chip designers can determine the best way to fit in all items in a nano-chip, keeping the required circuitry in mind.

The instant invention also includes a method for generating floor plans comprising the steps of:
(a) providing a system for generating floor plans comprising:
   a memory having a set of computer readable computer instructions, and a central processor for executing the set of computer readable computer instructions, the set of computer readable computer instructions including:
      one or more GAN models, with a first model (GAN-I) being a learning model for all types of floor plans to generate color-coded floor plans;
      a second model (GAN-II) being a learning model for all color-coded floor plans to generate original architectural plans;
(b) obtaining a first set of input data from a user of the system, the first set of input data including technical aspects of the floor plan;
(c) obtaining a second set of input data from a user of the system, the second set of input data including tastes and preferences of the user;
(d) creating a user profile based on the first set of input data and the second set of input data and storing the user profile in a database;
(e) applying a collaborative filter to the user profile to compare the user profiles to previous user profiles to locate similar users;
(f) locating floor plans chosen and liked by similar users within the database;
(g) applying a technical filter using the first set of input data to the floor plans chosen to obtain technical floor plans;
(h) applying a taste filter using the second set of input data to the floor plans chosen to obtain collaborative floor plans;
(i) generating original architectural plans based on the technical floor plans and the collaborative floor plans; and
(j) presenting original architectural plans to the user and allowing the user to download any floor plan(s) selected.

The method for generating floor plans can further include input data provided by a user of the system, the input data selected from the group comprising: number of bedrooms, number of bathrooms, budget, building materials, lot dimensions, number of stories, municipal restrictions, neighborhood restrictions, special needs (i.e., handicap access, limited mobility access), closet size, and the like.

Any method described herein may incorporate any design element contained within this application and any other document/application incorporated by reference herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention may be embodied in other forms without departing from the spirit and the essential attributes thereof, and, accordingly, reference should be made to the appended claims, rather than to the foregoing specification, as indicating the scope of the invention. The invention illustratively disclosed herein suitably may be practiced in the absence of any element which is not specifically disclosed herein.

1. A system for generating floor plans comprising:
a memory having a set of computer readable computer instructions, and a central processor for executing the set of computer readable computer instructions, the set of computer readable computer instructions including:
one or more GAN models, a first model (GAN-I) being a learning model for all types of floor plans to generate color-coded floor plans; and
a second model (GAN-II) being a learning model for all color-coded floor plans to generate original architectural plans.

2. The system for generating floor plans of claim 1 wherein a color code for each room is assigned and specified for each color-coded floor plan and the generated colored plans from the first model are cleaned using contour analysis.

3. The system for generating floor plans of claim 1 wherein color-coded floor plans from the first model are input to the GAN-II model to generate a black/white image of a generated floor plan.

4. The system for generating floor plans of claim 1 further including input data provided by a user of the system, the input data selected from the group comprising: number of bedrooms, number of bathrooms, budget, building materials, lot dimensions, number of stories, municipal restrictions, neighborhood restrictions, special needs (i.e., handicap access, limited mobility access), closet size, and the like.

5. The system for generating floor plans of claim 1, wherein the central processor comprises: one or more processors, one or more computers, one or more servers, and combinations thereof.

6. The system for generating floor plans of claim 1 wherein the first model (GAN-I) acquires or learns from existing floor plans obtained from any source available including, but not limited to, online, online databases, private databased, scanned documents, public databases, and the like.

7. A method for generating floor plans comprising the steps of:
providing a system for generating floor plans comprising:
a memory having a set of computer readable computer instructions, and a central processor for executing the set of computer readable computer instructions, the set of computer readable computer instructions including:
one or more GAN models, with a first model (GAN-I) being a learning model for all types of floor plans to generate color-coded floor plans;
a second model (GAN-II) being a learning model for all color-coded floor plans to generate original architectural plans;
obtaining a first set of input data from a user of the system, the first set of input data including technical aspects of the floor plan;
obtaining a second set of input data from a user of the system, the second set of input data including tastes and preferences of the user;
creating a user profile based on the first set of input data and the second set of input data and storing the user profile in a database;
applying a collaborative filter to the user profile to compare the user profiles to previous user profiles to locate similar users;
locating floor plans chosen and liked by similar users within the database;
applying a technical filter using the first set of input data to the floor plans chosen to obtain technical floor plans;
applying a taste filter using the second set of input data to the floor plans chosen to obtain collaborative floor plans;
generating original architectural plans based on the technical floor plans and the collaborative floor plans; and
presenting original architectural plans to the user and allowing the user to download any floor plan(s) selected.

8. The method for generating floor plans of claim 7 wherein a color code for each room is assigned and specified for each color-coded floor plan and the generated colored plans from the first model are cleaned using contour analysis.

9. The method for generating floor plans of claim 7 wherein color-coded floor plans from the first model are input to the GAN-II model to generate a black/white image of a generated floor plan.

10. The method for generating floor plans of claim 7 further including input data provided by a user of the system, the input data selected from the group comprising: number of bedrooms, number of bathrooms, budget, building materials, lot dimensions, number of stories, municipal restrictions, neighborhood restrictions, special needs (i.e., handicap access, limited mobility access), closet size, and the like.

11. The method for generating floor plans of claim 7, wherein the central processor comprises: one or more processors, one or more computers, one or more servers, and combinations thereof.

12. The method for generating floor plans of claim 7 wherein the first model (GAN-I) acquires or learns from existing floor plans obtained from any source available including, but not limited to, online, online databases, private databased, scanned documents, public databases, and the like.

13. A system for generating floor plans comprising:
a memory having a set of computer readable computer instructions, and a central processor for executing the set of computer readable computer instructions, the set of computer readable computer instructions including:
a pair of GAN models, a first model (GAN-I) being a learning model for all types of floor plans to generate color-coded floor plans; and
a second model (GAN-II) being a learning model for all color-coded floor plans to generate original architectural plans.

14. The system for generating floor plans of claim 13 wherein a color code for each room is assigned and specified for each color-coded floor plan and the generated colored plans from the first model are cleaned using contour analysis.

15. The system for generating floor plans of claim 13 wherein color-coded floor plans from the first model are input to the GAN-II model to generate a black/white image of a generated floor plan.

16. The system for generating floor plans of claim 13 further including input data provided by a user of the system, the input data selected from the group comprising: number of bedrooms, number of bathrooms, budget, building materials, lot dimensions, number of stories, municipal restrictions, neighborhood restrictions, special needs (i.e., handicap access, limited mobility access), closet size, and the like.

17. The system for generating floor plans of claim 13, wherein the central processor comprises: one or more processors, one or more computers, one or more servers, and combinations thereof.

18. The system for generating floor plans of claim 13 wherein the first model (GAN-I) acquires or learns from existing floor plans obtained from any source available including, but not limited to, online, online databases, private databased, scanned documents, public databases, and the like.
